(19) United States
(12) Patent Application Publication
(10) Pub. No.: US 2026/0128295 A1
(43) Pub. Date: May 7, 2026

(54) POSITIVE ELECTRODE ACTIVE MATERIAL AND LITHIUM ION SECONDARY BATTERY

(71) Applicant: HONDA MOTOR CO., LTD., Tokyo (JP)

(72) Inventors: Takashi HAKARI, Saitama (JP); Yuki CHIKAYASU, Saitama (JP); Yoshiyuki MORITA, Saitama (JP); Kazuki CHIBA, Saitama (JP); Kazumasa SAKATSUME, Saitama (JP); Koji NISHIGUCHI, Saitama (JP); Taku SAKATA, Saitama (JP)

(21) Appl. No.: 19/372,450

(22) Filed: Oct. 29, 2025

(30) Foreign Application Priority Data
Nov. 6, 2024 (JP) 2024-194261

(51) Int. Cl. H01M 4/505; H01M 4/02; H01M 4/131; H01M 4/525; H01M 10/0525

(52) U.S. Cl. CPC H01M 4/505; H01M 4/131; H01M 4/525; H01M 10/0525; H01M 2004/021; H01M 2004/028

(57) ABSTRACT

A cobalt-free positive electrode active material including a lithium nickel manganese composite oxide as a carrier,
particulate silicon dioxide is supported on a surface of the lithium nickel manganese composite oxide.

### BACKGROUND

### Technical Field

The present invention relates to a positive electrode active material and a lithium ion secondary battery.

### Related Art

In recent years, research and development on a secondary battery that contributes to improvement of energy efficiency have been conducted. In particular, a lithium ion secondary battery is becoming increasingly important as a power source for an electric vehicle (EV), a hybrid electric vehicle (HEV), or the like.

A positive electrode active material has attracted attention as an important component for determining a capacity of a lithium ion secondary battery, and development thereof has been advanced. As a positive electrode active material used for a lithium ion secondary battery, for example, a cobalt-free lithium nickel manganese composite oxide having a low resource risk has been reported (for example, Japanese Patent No. 7446486 and JP 2024-58607 A).

### CITATION LIST

### Patent Literature

Patent Literature 1: Japanese Patent No. 7446486
Patent Literature 2: JP 2024-58607 A

### SUMMARY

A lithium ion secondary battery using a cobalt-free lithium nickel manganese composite oxide as a positive electrode active material has a small discharge capacity as compared with a conventionally used nickel or cobalt-based material, and there is room for improvement.

The present invention has been made to solve the above problems, and an object of the present invention is to provide a positive electrode active material from which a lithium ion secondary battery capable of further increasing a discharge capacity can be obtained, and a lithium ion secondary battery using the positive electrode active material. This ultimately contributes to improvement of energy efficiency.

In order to achieve the above object, the present invention provides the following configurations.

[1] A cobalt-free positive electrode active material including a lithium nickel manganese composite oxide as a carrier,
particulate silicon dioxide is supported on a surface of the lithium nickel manganese composite oxide.

In the positive electrode active material according to [1], particulate silicon dioxide is supported on the surface of the lithium nickel manganese composite oxide. As a result, the decomposition of lithium carbonate as a high resistance layer is promoted, and the resistance of the lithium nickel manganese composite oxide can be reduced. Therefore, the discharge capacity of the lithium ion secondary battery using the positive electrode active material can be further increased. Therefore, the number of batteries required can be reduced, which can contribute to cost reduction. That is, it is possible to contribute to improvement of energy efficiency.

[2] The positive electrode active material according to [1], in which a mass ratio ((M₂/(M₁+M₂))×100) of a mass (M₂) of the particulate silicon dioxide to a sum (M₁+M₂) of the mass (M₁) of the lithium nickel manganese composite oxide and the mass (M₂) of the particulate silicon dioxide is more than 0% by mass and 2.0% by mass or less.

In the positive electrode active material according to [2], a mass ratio ((M₂/(M₁+M₂))×100) of a mass (M₂) of particulate silicon dioxide to a sum (M₁+M₂) of a mass (M₁) of lithium nickel manganese composite oxide and a mass (M₂) of particulate silicon dioxide satisfies a specific numerical range. Therefore, the resistance of the lithium nickel manganese composite oxide is further reduced, and the discharge capacity of the lithium ion secondary battery using the positive electrode active material is further increased. Therefore, cycle characteristics can be further improved, and this can contribute to further improvement of energy efficiency.

[3] The positive electrode active material according to [1] or [2], in which the particulate silicon dioxide has a particle diameter of 5 nm or more and 300 nm or less.

In the positive electrode active material according to [3], the particle diameter of particulate silicon dioxide satisfies a specific numerical range. Therefore, the resistance of the lithium nickel manganese composite oxide is further reduced, and the discharge capacity of the lithium ion secondary battery using the positive electrode active material is further increased. Therefore, cycle characteristics can be further improved, and this can contribute to further improvement of energy efficiency.

[4] The positive electrode active material according to any one of [1] to [3], in which the lithium nickel manganese composite oxide has an average particle diameter of 0.25 to 10 μm.

In the positive electrode active material according to [4], the average particle diameter of the lithium nickel manganese composite oxide satisfies a specific numerical range. Therefore, the productivity of the positive electrode active material can be further enhanced, and the electrochemical characteristics of the lithium ion secondary battery using the positive electrode active material can be further improved. Therefore, cycle characteristics can be further improved, and this can contribute to further improvement of energy efficiency.

[5] A lithium ion secondary battery including a positive electrode, a negative electrode, and an electrolyte, wherein the positive electrode contains the positive electrode active material according to any one of [1] to [4].

In the lithium ion secondary battery according to [5], the positive electrode contains the positive electrode active material. Therefore, the discharge capacity can be further increased, the number of batteries required can be reduced, which can contribute to cost reduction. That is, it is possible to contribute to improvement of energy efficiency.

The positive electrode active material and the lithium ion secondary battery according to the present invention can further increase a discharge capacity.

### BRIEF DESCRIPTION OF DRAWINGS

FIG. 1 is a flowchart illustrating a method for manufacturing a positive electrode active material according to the embodiment of the present invention;

FIG. 2 is a cross-sectional view schematically illustrating a lithium ion secondary battery according to the embodiment of the present invention;

FIG. 3 is a scanning electron microscope (SEM) image of a positive electrode active material according to the embodiment of the present invention;

FIG. 4 is an SEM image of a positive electrode active material used for SEM-energy dispersive X-ray spectroscopy (EDX);

FIG. 5 is a view illustrating a result of a spectrum of elemental analysis by SEM-EDX of a granular material on a surface of the positive electrode active material in FIG. 4;

FIG. 6 is a view illustrating a result of a spectrum of elemental analysis by SEM-EDX of a granular material in a cross section of the positive electrode active material in FIG. 4;

FIG. 7 is a view illustrating a result of a spectrum of elemental analysis by SEM-EDX of a surface of the positive electrode active material of FIG. 4;

FIG. 8 is a view illustrating a result of a spectrum of elemental analysis by SEM-EDX of a cross section of the positive electrode active material of FIG. 4;

FIG. 9 is a graph illustrating discharge capacities at a rate of 0.1 C of lithium ion secondary batteries using positive electrode active materials of Example 1 and Comparative Example 1;

FIG. 10 is a graph illustrating discharge capacities at a rate of 0.33 C of lithium ion secondary batteries using positive electrode active materials of Example 1 and Comparative Example 1;

FIG. 11 is a graph illustrating discharge capacities at a rate of 0.1 C of lithium ion secondary batteries using positive electrode active materials of Example 2 and Comparative Example 2; and

FIG. 12 is a graph illustrating discharge capacities at a rate of 0.33 C of lithium ion secondary batteries using positive electrode active materials of Example 2 and Comparative Example 2.

### DETAILED DESCRIPTION

Hereinafter, a preferred embodiment of the present invention will be described in detail.

### [Positive Electrode Active Material]

The positive electrode active material of the present embodiment is a cobalt-free positive electrode active material using a lithium nickel manganese composite oxide as a carrier. Here, “cobalt-free” means that the lithium nickel manganese composite oxide does not contain cobalt at all or inevitably contains a slight amount of cobalt.

In the positive electrode active material of the present embodiment, particulate silicon dioxide is supported on the surface of the lithium nickel manganese composite oxide.

As long as the function of the present invention is not impaired, the positive electrode active material may contain components other than the lithium nickel manganese composite oxide and silicon dioxide.

The positive electrode active material of the present embodiment may include only one kind or two or more kinds of lithium nickel manganese composite oxides.

When a lithium nickel manganese composite oxide is manufactured as a positive electrode active material, the composition ratio (Li:Ni:Mn) of the entire lithium nickel manganese composite oxide is also maintained in the obtained positive electrode active material. In addition, the composition ratio of the lithium nickel manganese composite oxide is adjusted so as to be similar to the composition ratio required for the positive electrode active material to be obtained.

### (Lithium Nickel Manganese Composite Oxide)

The lithium nickel manganese composite oxide of the present embodiment is a layered rock salt type oxide and is in a form of a particle having an outer layer on a surface thereof.

In the present specification, the average particle diameter of the particles of the lithium nickel manganese composite oxide (hereinafter, also simply referred to as “average particle diameter”) is not particularly limited, but is, for example, preferably 0.25 to 10 μm, more preferably 0.25 to 5.0 μm, and still more preferably 0.50 to 4.0 μm. When the average particle diameter is the above-described lower limit value or more, the productivity of the positive electrode active material can be further increased. When the average particle diameter is the above upper limit value or less, the electrochemical characteristics of the lithium ion secondary battery can be further improved.

The average particle diameter means, for example, D50 measured by a laser diffraction particle diameter distribution measuring apparatus or the like.

### <Chemical Composition>

In a conventional lithium nickel manganese composite oxide (for example, LiNi_{0.5}Mn_{0.5}O₂), lithium carbonate (Li₂CO₃) having low ion conductivity exists on the surface, and serves as a resistance layer, which is one of the causes of low capacity. On the other hand, when Li₂CO₃ on the surface is washed with water, the atmosphere and LiNi_{0.5}Mn_{0.5}O₂ are in direct contact with each other, thereby reacting with water, forming a new resistance layer, and decreasing the capacity. Therefore, in order to improve electrochemical characteristics as a positive electrode active material, it is necessary to remove Li₂CO₃ on the surface without touching water.

The present invention is based on the finding that by producing a battery by supporting particulate silicon dioxide (SiO₂) on the surface of LiNi_{0.5}Mn_{0.5}O₂, it is possible to create a state of being blocked from air, promote the decomposition of lithium carbonate (Li₂CO₃) as a high resistance layer during charging, and form an interface of a low resistance layer. Thus, in the present invention, the amount of Ni used can be reduced while the electrochemical characteristics of the positive electrode active material are maintained well.

The lithium nickel manganese composite oxide of the present embodiment is represented by the following formula (1).

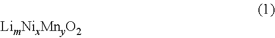

In the formula (1), m is in a range of 1.0≤m≤1.06, x is in a range of 0.47≤x≤0.5, y is in a range of 0.47≤y≤0.5, and m+x+y=2.

The lithium nickel manganese composite oxide of the present embodiment more preferably has m in the range of 1.02≤m≤1.04, x in the range of 0.48≤x≤0.49, and y in the range of 0.48≤y≤0.49 in the formula (1). Specifically, the lithium nickel manganese composite oxide used in the present invention has a chemical composition ranging from Li_{1.02}Ni_{0.49}Mn_{0.49}O₂ to Li_{1.04}Ni_{0.48}Mn_{0.48}O₂.

The chemical composition of the lithium nickel manganese composite oxide of the present embodiment can be determined by inductively coupled plasma (ICP) emission spectrometry.

The lithium nickel manganese composite oxide particles have an outer layer on the surface.

In the present specification, the “outer layer” refers to a region up to 25 nm from a surface of a particle toward the inside of the particle. Note that when a particle diameter is less than 50 nm, the particle has a single layer structure composed only of an outer layer.

The particles of the lithium nickel manganese composite oxide of the present embodiment may be primary particles or secondary particles. The particle of the lithium nickel manganese composite oxide is preferably a secondary particle in which a plurality of primary particles are aggregated with each other from a viewpoint that relatively dense particles can be obtained.

The lithium nickel manganese composite oxide of the present embodiment supports particulate silicon dioxide on the surface. That is, the lithium nickel manganese composite oxide of the present embodiment functions as a carrier.

### (Silicon Dioxide)

The silicon dioxide of the present embodiment is supported on the surface of the lithium nickel manganese composite oxide as particles.

The particle diameter of silicon dioxide is preferably 5 nm or more and 300 nm or less, more preferably 10 nm or more and 100 nm or less, still more preferably 10 nm or more and 50 nm or less. When the particle diameter of silicon dioxide is the above lower limit value or more, aggregation of particles can be suppressed, and silicon dioxide is easily supported on the surface of the lithium nickel manganese composite oxide. When the particle diameter of silicon dioxide is the above upper limit value or less, silicon dioxide is easily supported on the surface of the lithium nickel manganese composite oxide.

The particle diameter of silicon dioxide is determined, for example, by observation with a transmission electron microscope or the like.

The mass of the lithium nickel manganese composite oxide is defined as M₁, and the mass of the silicon dioxide is defined as M₂.

At this time, the mass ratio of the mass of silicon dioxide ((M₂/(M₁+M₂))×100) with respect to the total (M₁+M₂) of the mass of the lithium nickel manganese composite oxide and the mass of silicon dioxide is preferably more than 0% by mass and 2.0% by mass or less, more preferably 0.05% by mass or more and 1.0% by mass or less, and still more preferably 0.1% by mass or more and 0.9% by mass or less. When the mass ratio of silicon dioxide is the lower limit value or more, the resistance of the lithium nickel manganese composite oxide can be further reduced. When the mass ratio of silicon dioxide is the above upper limit value or less, it is possible to suppress silicon dioxide from covering the surface of the lithium nickel manganese composite oxide in a layer form, and to further reduce the resistance of the lithium nickel manganese composite oxide.

In the positive electrode active material of the present embodiment, since particulate silicon dioxide is supported on the surface of the lithium nickel manganese composite oxide, the resistance of the lithium nickel manganese composite oxide can be further reduced, and the discharge capacity of the lithium ion secondary battery using the positive electrode active material can be further increased.

It is considered that when silicon dioxide covers the entire surface of the lithium nickel manganese composite oxide in a layer form, charge transfer of lithium is rather inhibited, and the resistance of the lithium nickel manganese composite oxide cannot be reduced. Therefore, it is considered to be important that silicon dioxide is supported on the surface of the lithium nickel manganese composite oxide as particles.

Whether or not silicon dioxide is supported as particles on the surface of the lithium nickel manganese composite oxide can be adjusted by the average particle diameter and mass ratio of silicon dioxide, the heat treatment temperature in the firing step described later, and a combination thereof.

The fact that particulate silicon dioxide is supported on the surface of the lithium nickel manganese composite oxide can be confirmed by using energy dispersive X-ray spectroscopy (EDX) using a scanning electron microscope (SEM).

When the positive electrode active material of the present embodiment is applied to a lithium ion secondary battery including a liquid electrolyte (electrolytic solution), silicon dioxide is considered to function as an adsorbent that adsorbs decomposition products in the electrolytic solution. Therefore, it is considered that the interface of the low resistance layer can be formed, and the resistance of the lithium nickel manganese composite oxide can be reduced. As a result, the discharge capacity of the lithium ion secondary battery using the positive electrode active material of the present embodiment can be further increased.

In addition, it is considered that in the lithium ion secondary battery using the positive electrode active material of the present embodiment, the activation energy of the electrochemical reaction is reduced, and the electrochemical reaction is likely to occur. This is considered that the particulate silicon dioxide supported on the lithium nickel manganese composite oxide functions as a catalyst for an electrochemical reaction of the lithium ion secondary battery.

### [Method for Manufacturing Positive Electrode Active Material]

The positive electrode active material of the present embodiment contains the above-described lithium nickel manganese composite oxide. As a lithium source of the lithium nickel manganese composite oxide, it is possible to use a known compound such as a hydroxide such as lithium hydroxide monohydrate (LiOH·H₂O), a carbonate such as lithium carbonate (Li₂CO₃), or an acetate such as lithium acetate (CH₃COOLi) and lithium acetate dihydrate (CH₃COOLi·2H₂O), and there is no particular limitation. In the compounds of the nickel source and the manganese source of the transition metal, known oxides, hydroxides, or metal salts of nickel and manganese can be widely used, and are not particularly limited.

For example, as the nickel compound, nickel hydroxide (Ni(OH)₂), nickel(II) chloride (NiCl₂), nickel(II) chloride hexahydrate (NiCl₂·6H₂O), and nickel(II) nitrate hexahydrate (Ni(NO₃)₂·6H₂O) can be used, but the nickel compound is not limited thereto.

As the manganese compound, manganese(II) chloride (MnCl₂), manganese(II) chloride tetrahydrate (MnCl₂·4H₂O), manganese carbonate hexahydrate (MnCO₃·6H₂O), manganese(II) nitrate hexahydrate (Mn(NO₃)₂·6H₂O) and the like can be used, but there is no limitation thereto.

The transition metal compounds can be used not only singly but also as a composite hydroxide (for example, nickel-manganese composite hydroxides) or the like by using a coprecipitation method or the like.

### “Preparation of Lithium Nickel Manganese Composite Oxide”

In the preparation of the lithium nickel manganese composite oxide, first, a predetermined amount of a lithium compound is added to the nickel-manganese compound of the intermediate, and the mixture is dispersed in a solvent such as ethanol and mixed. Incidentally, a predetermined amount of the intermediate compound and a predetermined amount of the lithium compound may be mixed not only by wet mixing using a solvent but also by dry mixing not using a solvent. For example, in a case of synthesizing Li_{1.04}Ni_{0.48}Mn_{0.48}O₂, Li₂CO₃ by using lithium carbonate (Li₂CO₃) as a lithium compound, Li₂CO₃ is preferably weighed more than the stoichiometric ratio by 1% by mass to 5% by mass, for example, 2% by mass.

The nickel-manganese compound can be synthesized by a known method. In a case where the nickel-manganese compound is a hydroxide, for example, nickel sulfate hexahydrate (NiSO₄·6H₂O) and manganese sulfate pentahydrate (MnSO₄·5H₂O) are weighed so that a molar ratio of Ni:Mn becomes 1:1, pure water is added thereto to dissolve the compounds, and an aqueous alkali solution is added dropwise to the aqueous sulfate solution, and thereby the compounds can be coprecipitated as a nickel-manganese composite hydroxide.

The lithium nickel manganese composite oxide of the present embodiment can be synthesized using a known method. For example, the synthesis can be performed as follows: a composite hydroxide or a composite oxide of a nickel compound and a manganese compound is prepared as an intermediate compound, the intermediate compound and a lithium compound are mixed to obtain a raw material mixture, and the raw material mixture is heat-treated (for example, fired) at a predetermined temperature for a predetermined time in a predetermined atmosphere.

A mixture of a lithium compound and a nickel-manganese compound as a precursor is pulverized into a preferable size, mixed, and then filled in a crucible or the like, and the mixture is heat-treated. As the crucible, an alumina sagger, an alumina crucible, a platinum crucible, a gold crucible, or the like is used. In the heat treatment of the mixture, for example, a firing furnace or a roller hearth kiln is used.

The mixture put into the sagger or the crucible is heated to reach a heat treatment temperature at a temperature-rising rate of 5° C./min to 25° C./min, and preferably 10° C./min to 25° C./min. A heat treatment atmosphere is not particularly limited, and examples thereof include the atmosphere (under an air atmosphere), an oxygen flow, and the like. The heat treatment atmosphere is preferably an oxygen flow. A heat treatment time can be appropriately set according to a heat treatment temperature. Note that the heat treatment time means time for holding the heat treatment temperature.

In a case where the mixture of the lithium compound (for example, Li₂CO₃) and the nickel-manganese compound is heat-treated, the heat treatment temperature is preferably 1025° C. or more and 1150° C. or less, and more preferably 1050° C. or more and 1125° C. or less. The heat treatment time is preferably 1 minute to 7 hours, more preferably 2 minutes to 6 hours, still more preferably 3 minutes to 5 hours, and particularly preferably 5 minutes to 3 hours.

By the above method, a lithium nickel manganese composite oxide is obtained.

Hereinafter, a method for manufacturing the positive electrode active material of the present embodiment will be described in detail with reference to the drawings.

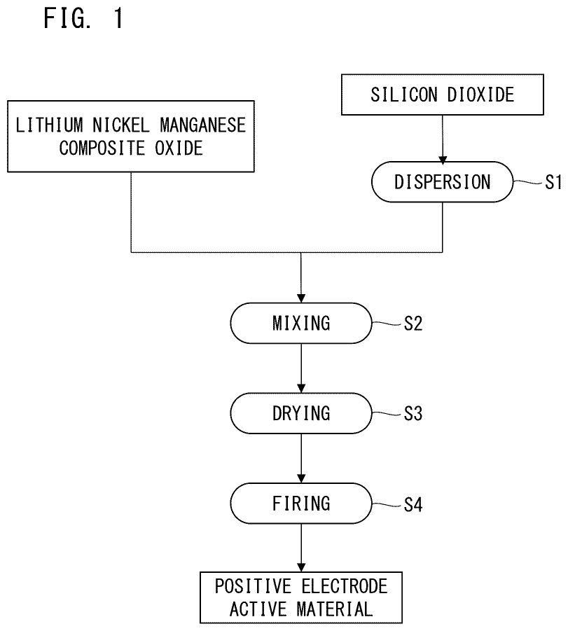

FIG. 1 illustrates a flowchart of a method for manufacturing a positive electrode active material of the present embodiment.

As illustrated in FIG. 1, the method for manufacturing a positive electrode active material of the present embodiment includes a dispersion step (S1), a mixing step (S2), a drying step (S3), and a firing step (S4).

### <Dispersion Step (S1)>

The dispersion step (S1) is a step of dispersing and mixing silicon dioxide in a solvent.

Silicon dioxide is preferably nano oxide particles having an average particle diameter of 5 nm or more and 300 nm or less.

As the nano oxide particles, a commercially available product may be used. Examples of commercially available products of the nano oxide particles include silicon dioxide nanopowder, 5 to 20 nm particle size, manufactured by Aldrich, Silica nanoparticles, 300 nm particle size, manufactured by Aldrich, and the like.

Examples of the solvent used in the dispersion step include alcohols such as methanol and ethanol, ketones such as acetone and methyl ethyl ketone, ethers such as dimethyl ether and diethyl ether, and esters such as methyl acetate and ethyl acetate. Among these solvents, alcohols are preferable, and ethanol is more preferable from the viewpoint of excellent dispersibility and cost. The ethanol may be an aqueous solution.

In the dispersion step, particulate silicon dioxide is placed in a container with a solvent, and stirred to disperse the silicon dioxide in the solvent.

The method of stirring is not particularly limited, and examples thereof include a method of stirring using a stirring bar.

The treatment time (stirring time) in the dispersion step is not particularly limited, but is preferably, for example, 10 minutes to 60 minutes.

The treatment temperature in the dispersion step is not particularly limited, but is preferably, for example, 5 to 30° C.

### <Mixing Step (S2)>

The mixing step (S2) is a step of mixing the lithium nickel manganese composite oxide with the dispersion liquid of silicon dioxide and a solvent obtained in the dispersion step.

The lithium nickel manganese composite oxide is preferably particles having an average particle diameter of 0.25 to 10 μm.

In the mixing step, a particulate lithium nickel manganese composite oxide is placed in a container with a solvent, and the dispersion liquid of silicon dioxide and the solvent obtained in the dispersion step is further added and stirred to mix the lithium nickel manganese composite oxide and the silicon dioxide.

Examples of the solvent used in the mixing step include the similar solvents as the solvents used in the dispersion step, and the same solvents as the solvents used in the dispersion step are preferable. Specifically, as the solvent used in the step, alcohols are preferable, and ethanol is more preferable. The ethanol may be an aqueous solution.

The method of stirring is not particularly limited, and examples thereof include a method of stirring using a stirring bar.

The treatment time (stirring time) in the mixing step is not particularly limited, but is preferably, for example, 10 minutes to 60 minutes.

The treatment temperature in the mixing step is not particularly limited, but is preferably, for example, 5 to 30° C.

### <Drying Step (S3)>

The drying step (S3) is a step of drying the mixed liquid of lithium nickel manganese composite oxide and silicon dioxide obtained in the mixing step.

In the drying step, the mixed liquid is dried using a drying device such as an oven to obtain a mixture in which particulate silicon dioxide is attached to the surface of the lithium nickel manganese composite oxide.

The treatment time (drying time) in the drying step is not particularly limited, but is preferably, for example, 2 hours to 8 hours.

The drying time refers to a time from when the mixed liquid is put in a drying device and heating is started to when the heating is stopped and the inside of the drying device returns to normal temperature (for example, 5 to 30° C.).

The treatment temperature in the drying step is preferably, for example, 80 to 120° C.

### <Firing Step (S4)>

The firing step (S4) is a step of heating and firing the mixture obtained in the drying step.

In the firing step, the mixture is placed in a firing apparatus such as a firing furnace and subjected to a heat treatment to obtain a positive electrode active material in which particulate silicon dioxide is supported on the surface of the lithium nickel manganese composite oxide.

The treatment time (time for heat treatment) in the firing step is not particularly limited, but is preferably, for example, 1 hour to 8 hours.

The time for performing the heat treatment refers to the time from when the mixture is put into a firing apparatus and heating is started until the inside of the firing apparatus returns to normal temperature (for example, 5 to 30° C.) after heating is stopped.

The treatment temperature in the firing step is, for example, preferably 200° C. or more and 500° C. or less, and more preferably 300° C. or more and 400° C. or less. When the treatment temperature in the firing step is the above lower limit value or more, the catalytic activity of silicon dioxide is further enhanced. When the treatment temperature in the firing step is the above upper limit value or less, the supporting amount of silicon dioxide on the surface of the lithium nickel manganese composite oxide can be sufficiently maintained.

In the firing step, the mixture placed in the firing apparatus is heated at a heating rate of 5° C./min to 25° C./min, preferably 10° C./min to 25° C./min so as to reach the treatment temperature. A heat treatment atmosphere is not particularly limited, and examples thereof include the atmosphere (under an air atmosphere), an oxygen flow, and the like. The heat treatment atmosphere is preferably an oxygen flow.

After the heat treatment is performed, cooling is preferably performed so as to reach normal temperature (for example, 5 to 30° C.) at a temperature falling rate of 5° C./min to 25° C./min, preferably 10° C./min to 25° C./min.

Through the above steps, the positive electrode active material of the present embodiment is obtained.

### [Lithium Ion Secondary Battery]

The lithium ion secondary battery of the present embodiment includes a positive electrode, a negative electrode, and an electrolyte, and the positive electrode contains a positive electrode active material in which particulate silicon dioxide is supported on the surface of the above-described lithium nickel manganese composite oxide. The lithium ion secondary battery of the present embodiment may include other battery elements as necessary.

In the lithium ion secondary battery of the present embodiment, the battery element of the known lithium ion secondary battery can be adopted as it is except that the positive electrode contains a positive electrode active material in which particulate silicon dioxide is supported on the surface of the lithium nickel manganese composite oxide described above. The lithium ion secondary battery of the present embodiment may have any of a coin type, a button type, a cylindrical type, a square type, and a laminate type. In addition, the lithium ion secondary battery of the present embodiment can be applied to a wide range of applications such as a mobile device such as a mobile phone or a laptop computer, and in-vehicle applications.

Hereinafter, as for the lithium ion secondary battery of the present embodiment, a lithium ion secondary battery (coin-type lithium ion secondary battery) using an electrolytic solution will be described.

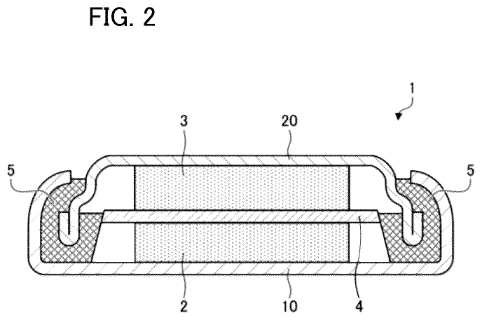

FIG. 2 is a cross-sectional view schematically illustrating the lithium ion secondary battery according to the present embodiment. FIG. 2 illustrates an example in which the lithium ion secondary battery of the present embodiment is a coin-type lithium ion secondary battery. As illustrated in FIG. 2, a lithium ion secondary battery 1 of the present embodiment includes a negative electrode can (negative electrode terminal) 20, a negative electrode 3, a separator 4 impregnated with an electrolytic solution, an insulating packing (gasket) 5, a positive electrode 2, and a positive electrode can 10.

The positive electrode can 10 is disposed on a lower side of the separator 4, the negative electrode can 20 is disposed on an upper side of the separator 4, and an outer shape of the lithium ion secondary battery 1 is formed by the positive electrode can 10 and the negative electrode can 20. The positive electrode 2 and the negative electrode 3 are disposed between the positive electrode can 10 and the negative electrode can 20 with the separator 4 impregnated with an electrolytic solution interposed therebetween, and the positive electrode 2 and the negative electrode 3 are separated from each other by the separator 4. The positive electrode can 10 and the negative electrode can 20 are electrically insulated from each other by the insulating packing 5.

In the lithium ion secondary battery 1, the positive electrode 2 can be prepared by blending a conductive agent, a binder, and the like with the positive electrode active material of the present embodiment as necessary to prepare a positive electrode mixture, and pressing the positive electrode mixture to a current collector (not illustrated).

As the current collector, a stainless steel mesh, an aluminum foil, or the like can be preferably used. As the conductive agent, acetylene black, ketjen black, or the like can be preferably used. As the binder, tetrafluoroethylene, polyvinylidene fluoride, or the like can be preferably used.

Blending of the positive electrode active material, the conductive agent, and the binder in the positive electrode mixture is not particularly limited. The content of the conductive agent in the positive electrode mixture is preferably 1% by mass to 15% by mass, and more preferably 0.1% by mass to 5% by mass. The content of the binder in the positive electrode mixture is preferably 0.1% by mass to 10% by mass, and more preferably 0.1% by mass to 5% by mass. It is preferable to blend the positive electrode active material, the conductive agent, and the binder such that a remainder (a portion other than the positive electrode active material and the conductive agent) in the positive electrode mixture is the positive electrode active material.

In the lithium ion secondary battery 1, as the negative electrode 3 with respect to the positive electrode 2, a known electrode that functions as a negative electrode active material and can intercalate and release lithium, for example, a metal-based material such as metallic lithium or a lithium alloy, a carbon-based material such as graphite or mesocarbon microbeads (MCMB), or a silicon-based material such as silicon (Si), a Si alloy, or silicon oxide can be adopted.

Known battery elements can be adopted as the separator 4 and the battery containers (positive electrode can 10 and negative electrode can 20).

As the electrolyte, a known electrolytic solution or the like can be employed. As the electrolytic solution, for example, a solution obtained by dissolving an electrolyte such as lithium perchlorate or lithium hexafluorophosphate in a solvent such as ethylene carbonate (EC), dimethyl carbonate (DMC), propylene carbonate (PC), or diethyl carbonate (DEC) can be used.

In the lithium ion secondary battery 1 of the present embodiment, since the positive electrode 2 contains a positive electrode active material in which particulate silicon dioxide is supported on the surface of the lithium nickel manganese composite oxide described above, the capacity can be increased.

### EXAMPLES

Next, examples of the present invention will be described, but the present invention is not limited to the examples below.

“Preparation of Lithium Nickel Manganese Composite Oxide: LiNi_{0.5}Mn_{0.5}O₂”

Li₂CO₃ (manufactured by Kojundo Chemical Lab. Co., Ltd.) and Ni_{0.5}Mn_{0.5}(OH)₂ (manufactured by Sigma-Aldrich Co. LLC.) were weighed so that Li:Ni:Mn=1:0.5:0.5 in terms of molar ratio, and in consideration of Li evaporation, they were weighed so that Li₂CO₃ was increased by 3% by mass based on the stoichiometric ratio. The total mass of Li₂CO₃ (manufactured by Kojundo Chemical Lab. Co., Ltd.) and Ni_{0.5}Mn_{0.5}(OH)₂ (manufactured by Sigma-Aldrich Co. LLC.) was set to 2.1 g. The materials were dispersed and mixed in ethanol in a mortar. Thereafter, the resulting mixture was filled in a JIS standard platinum crucible. The mixture filled in the platinum crucible was heated in the air at a temperature-rising rate of 15° C./min and fired at 1100° C. for 5 minutes using a firing furnace, and then the obtained powder was left to stand until the temperature of the powder reached room temperature (25° C.) to obtain a lithium nickel manganese oxide.

### “Preparation of Positive Electrode Active Material”

Into a 100 ml beaker with 50 mL of ethanol (manufactured by FUJIFILM Wako Pure Chemical Corporation, purity: 99.5%), 0.03 g of particulate silicon dioxide (manufactured by Aldrich, particle diameter 5-20 nm) was put, and the mixture was stirred for 30 minutes under an environment of 25° C. using a stirrer to be dispersed (dispersion step).

In the silicon dioxide dispersion liquid obtained in the above step, 9.97 g of the lithium nickel manganese oxide obtained in the above “Preparation of lithium nickel manganese composite oxide” was put, and was stirred for 10 minutes under an environment of 25° C. using a stirring bar and mixed (mixing step). The mass ratio of the lithium nickel manganese composite oxide and the silicon dioxide was 99.7:0.3.

The resulting mixed liquid was placed in an oven and dried at 80° C. for 20 hours (drying step).

In a platinum crucible conforming to JIS standard, 10 g of the obtained mixture was filled, and the mixture filled in the platinum crucible in air was heated at a temperature raising rate of 15° C./min and fired at 400° C. for 4 hours using a firing furnace (firing step). Thereafter, the resulting powder was allowed to stand until the temperature reached room temperature (25° C.) to obtain a positive electrode active material.

### “Imaging by SEM”

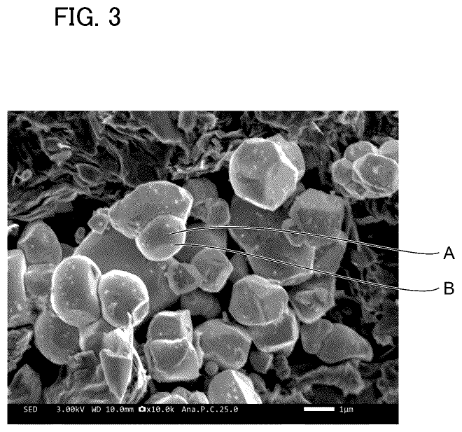

The obtained positive electrode active material was imaged by SEM (manufactured by JEOL Ltd., model number JSM-IT800) at a magnification of 10,000 times. The results are illustrated in FIG. 3.

As illustrated in FIG. 3, the obtained positive electrode active material was an aggregate of primary particles (A) having a major axis of about 1 to several μm. Some of the primary particles (A) were aggregated to form secondary particles. Small white granular materials (B) were observed on the surface of the primary particles (A).

### “Analysis by SEM-EDX”

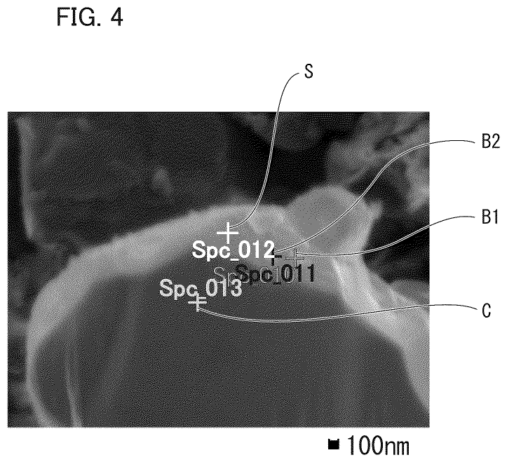

A cross-sectional material obtained by preparing a powder sample using a cross section polisher (manufactured by JEOL Ltd., model number IB-19520CP) was imaged at a magnification of 33000 times, and an SEM image of the positive electrode active material was analyzed by SEM-EDX (manufactured by JEOL Ltd., model number JSM-IT800). FIG. 4 illustrates SEM images used for analysis by SEM-EDX.

As illustrated in FIG. 4, the positive electrode active material was particles having a surface(S) and a cross section (C). White granular materials (B1) and (B2) were observed in some places on the surface(S) of the particles.

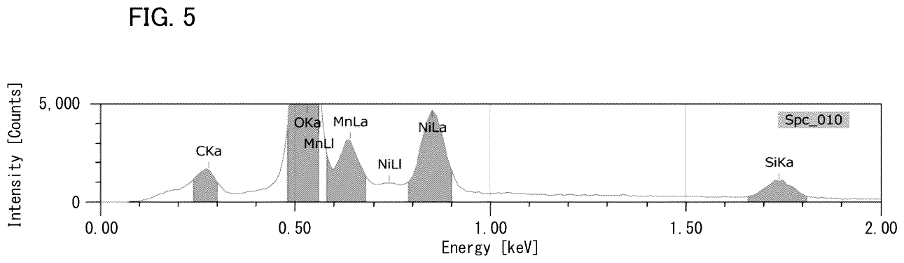

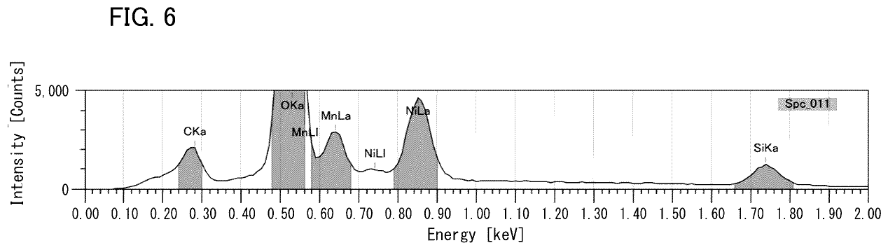

The results of spectra obtained by performing elemental analysis of the white granular materials (B1) and (B2) by SEM-EDX are illustrated in FIGS. 5 and 6, respectively. The results of the composition analysis are shown in Table 1.

As illustrated in FIGS. 5 and 6, in the white granular materials (B1) and (B2), a peak of Si was observed in a range of energy of 1.70 to 1.80 keV. From this, the white granular materials (B1) and (B2) are considered to be SiO₂ particles.

TABLE 1

| | Element (% by mass) | | | | | |
|---|---|---|---|---|---|---|
| | C | O | Si | Mn | Ni | Total |
| White granular material (B1) | 1.73 | 34.28 | 10.50 | 31.24 | 22.26 | 100.0 |
| White granular material (B2) | 2.55 | 32.83 | 12.21 | 29.81 | 22.60 | 100.0 |
| Surface (S) | 2.03 | 32.14 | 0.28 | 36.40 | 29.16 | 100.0 |
| Cross section (C) | 0.50 | 34.97 | 0.19 | 34.05 | 30.28 | 100.0 |

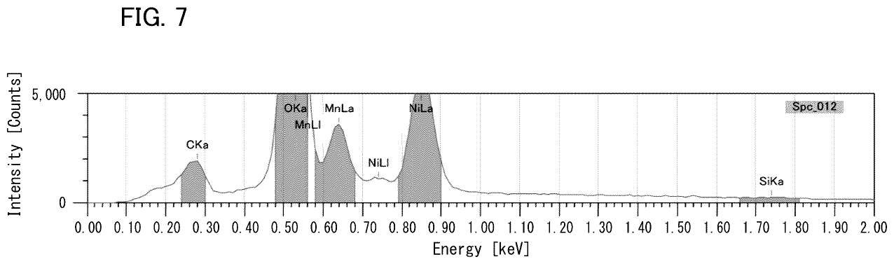

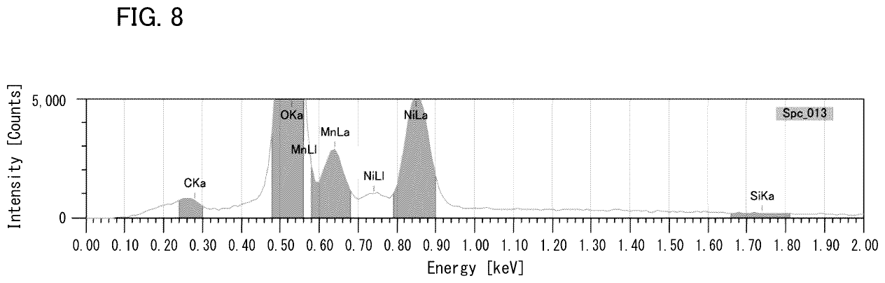

Next, the results of spectra of elemental analysis of the surface(S) and the cross section (C) by SEM-EDX are illustrated in FIGS. 7 and 8, respectively. The results of the composition analysis are shown in Table 1.

As illustrated in FIGS. 7 and 8, no peak of Si was observed on the surface(S) and the cross section (C). From this, it was confirmed that SiO₂ was not present on the surface(S) without the white granular materials (B1) and (B2).

From the fact that SiO₂ did not exist in the cross section (C), it was confirmed that SiO₂ did not penetrate into the particles of the positive electrode active material and was distributed in an island shape on the surface(S) as a granular material rather than in a layered form. From this, it was confirmed that SiO₂ was supported on the surface(S) of the lithium nickel manganese composite oxide as a granular material.

In addition, from Table 1, the content of carbon in the surface(S) of the lithium nickel manganese composite oxide is larger than that in the cross section (C), and from the analysis results so far, it is considered that these carbons are derived from lithium carbonate. When the surface(S) is compared with the white granular materials (B1) and (B2), there is no large difference in the content of carbon regardless of the presence or absence of SiO₂. From this, it is considered that LiₓSiO_{y} is not formed on the surface(S) by the following reaction formula.

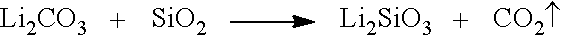

From the above results, it was confirmed that the primary particles (A) in FIG. 3 were lithium nickel manganese composite oxide, and the white granular material (B) was silicon dioxide (SiO₂).

“Preparation 1 of Positive Electrode Active Material in which Content of SiO₂ is Changed”

### Example 1 and Comparative Example 1

Each positive electrode active material was prepared in a similar manner to the “Preparation of positive electrode active material” except that the lithium nickel manganese composite oxide and the silicon dioxide were mixed at a mass ratio of 99.97:0.03, 99.95:0.05, 99.93:0.07, 99.9:0.1, 99.7:0.3, 99.5:0.5, 99:1, 98:2, and 97:3 (as described above, Example 1).

In addition, a lithium nickel manganese composite oxide prepared by a method similar to the method described in the “Preparation of lithium nickel manganese composite oxide: LiNi_{0.5}Mn_{0.5}O₂” was prepared except that the conditions for firing the mixture filled in the platinum crucible in the “Preparation of lithium nickel manganese composite oxide: LiNi_{0.5}Mn_{0.5}O₂” were 1075° C. and 30 minutes (Comparative Example 1).

The lithium nickel manganese composite oxide used in Example 1 and Comparative Example 1 had an average particle diameter (D50) of 4.1 μm as measured with a laser diffraction particle diameter distribution analyzer or the like.

### “Preparation of Lithium Ion Secondary Battery”

The positive electrode active material of Example 1 and the lithium nickel manganese composite oxide of Comparative Example 1 as a positive electrode active material, acetylene black (AB) as a conductive agent, and polyvinylidene fluoride (PVDF) as a binder were blended in a weight ratio of 8:1:1 by using N-methyl-2-pyrrolidone (NMP) as a solvent to prepare slurry. Thereafter, an aluminum foil having a thickness of 15 μm was coated with the slurry and was dried to prepare a positive electrode having a diameter of 14 φ. A coating area density was set to 4.5 mg/cm², and a volume density was set to 2.3 g/cm³. With respect to the positive electrode, a lithium metal having a thickness of 200 μm and a diameter of 16 φ was used as a counter electrode, and a polyethylene microporous film having a thickness of 20 μm and a diameter of 18 φ was used as a separator. A 1.2 mol/L solution obtained by dissolving lithium hexafluorophosphate (LiPF₆) in a mixed solvent of ethylene carbonate (EC), dimethyl carbonate (DMC), and ethyl methyl carbonate (EMC) (volume ratio: 3:4:3) was used as an electrolytic solution, and a lithium ion secondary battery (2032 coin-type cell) having the structure illustrated in FIG. 2 was prepared. The battery was prepared according to a known cell configuration and assembly method.

### “Charge and Discharge Test 1”

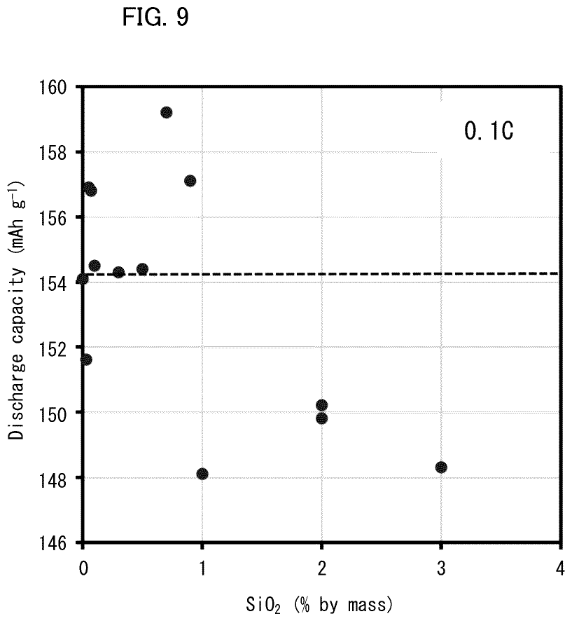

Each of the prepared lithium ion secondary batteries was subjected to a charge and discharge test at a constant current at a rate of 0.1 C (1 C: 250 mA/g), a current density of 12.5 mA/g, a cutoff potential of 4.7 V to 2.5 V or 4.8 V to 2.5 V under a temperature condition of 25° C. to evaluate each discharge capacity. The results are illustrated in FIG. 9. The broken line in FIG. 9 represents the discharge capacity of the lithium ion secondary battery of Comparative Example 1.

As illustrated in FIG. 9, the discharge capacity of the lithium ion secondary battery of Comparative Example 1 using the positive electrode active material in which silicon dioxide was not supported on the lithium nickel manganese composite oxide was 154.1 mAhg⁻¹.

On the other hand, the discharge capacity of the lithium ion secondary battery of Example 1 using the positive electrode active material in which silicon dioxide was supported on the lithium nickel manganese composite oxide exceeded the discharge capacity of Comparative Example 1 when the mass ratio of silicon dioxide was 0.05% by mass or more and 0.9% by mass or less. From this, it was confirmed that when the mass ratio of silicon dioxide was 0.05% by mass or more and 0.9% by mass or less, the discharge capacity was further increased.

### “Charge and Discharge Test 2”

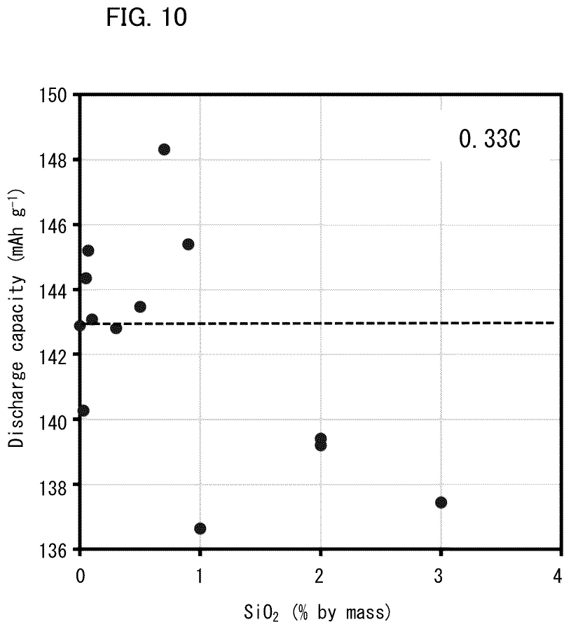

A charge and discharge test was performed in a similar manner to the “charge and discharge test 1” except that the rate of the charge and discharge test was changed to 0.33 C, and the discharge capacity of each test piece was evaluated. The results are illustrated in FIG. 10. The broken line in FIG. 10 represents the discharge capacity of the lithium ion secondary battery of Comparative Example 1.

As illustrated in FIG. 10, the discharge capacity of the lithium ion secondary battery of Comparative Example 1 using the positive electrode active material in which silicon dioxide was not supported on the lithium nickel manganese composite oxide was 142.9 mAhg⁻¹.

On the other hand, the discharge capacity of the lithium ion secondary battery of Example 1 using the positive electrode active material in which silicon dioxide was supported on the lithium nickel manganese composite oxide exceeded the discharge capacity of Comparative Example 1 when the mass ratio of silicon dioxide was 0.05% by mass or more and 0.9% by mass or less. From this, it was confirmed that when the mass ratio of silicon dioxide was 0.05% by mass or more and 0.9% by mass or less, the discharge capacity was further increased.

“Preparation 2 of Positive Electrode Active Material in which Content of SiO₂ is Changed”

### Example 2 and Comparative Example 2

Each positive electrode active material was prepared in a similar manner to the method described in the above “Preparation of positive electrode active material” except that lithium nickel manganese composite oxide and silicon dioxide were mixed at a mass ratio of 99.7:0.3, 99.3:0.7, 99:1, 98.5:1.5, 98:2, and 97:3 (as described above, Example 2).

In addition, a lithium nickel manganese composite oxide prepared by a method similar to the method described in the “Preparation of lithium nickel manganese composite oxide: LiNi_{0.5}Mn_{0.5}O₂” was prepared except that the conditions for firing the mixture filled in the platinum crucible in the “Preparation of lithium nickel manganese composite oxide: LiNi_{0.5}Mn_{0.5}O₂” were 1075° C. and 30 minutes (Comparative Example 2.

The lithium nickel manganese composite oxide used in Example 2 and Comparative Example 2 had an average particle diameter (D50) of 3.6 μm as measured with a laser diffraction particle diameter distribution analyzer or the like.

### “Preparation of Lithium Ion Secondary Battery”

Lithium ion secondary batteries were prepared in a similar manner to in Example 1 and Comparative Example 1 except that each of the positive electrode active material of Example 2 and the lithium nickel manganese composite oxide of Comparative Example 2 was used as a positive electrode active material.

### “Charge and Discharge Test 3”

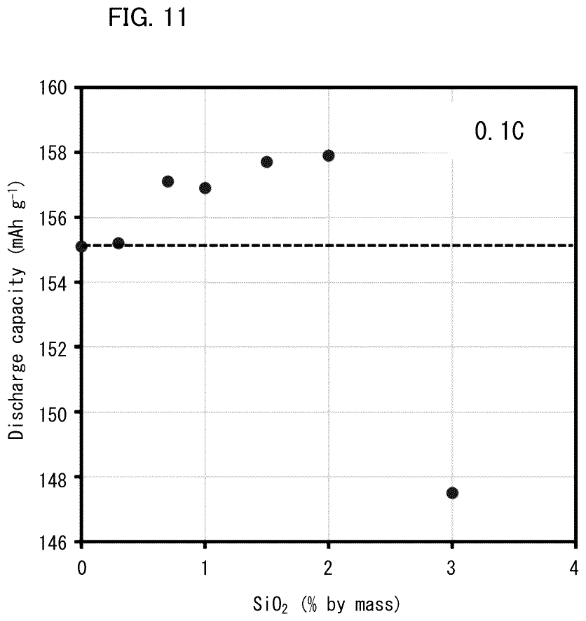

A charge and discharge test was performed in a similar manner to the “charge and discharge test 1”, and each discharge capacity was evaluated. The results are illustrated in FIG. 11. The broken line in FIG. 11 represents the discharge capacity of the lithium ion secondary battery of Comparative Example 2.

As illustrated in FIG. 11, the discharge capacity of the lithium ion secondary battery of Comparative Example 2 using the positive electrode active material in which silicon dioxide was not supported on the lithium nickel manganese composite oxide was 155.1 mAhg⁻¹.

On the other hand, the discharge capacity of the lithium ion secondary battery of Example 2 using the positive electrode active material in which silicon dioxide was supported on the lithium nickel manganese composite oxide exceeded the discharge capacity of Comparative Example 2 when the mass ratio of silicon dioxide was more than 0% by mass and 2.0% by mass or less. From this, it was confirmed that when the mass ratio of silicon dioxide was more than 0% by mass and 2.0% by mass or less, the discharge capacity was further increased.

### “Charge and Discharge Test 4”

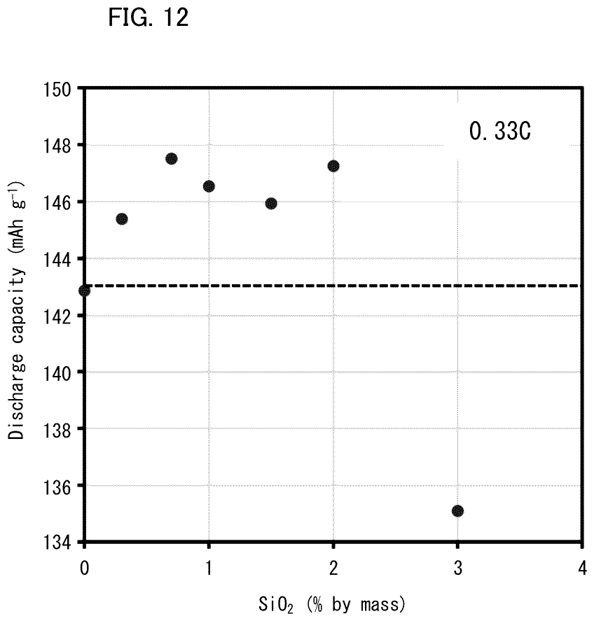

A charge and discharge test was performed in a similar manner to the “charge and discharge test 3” except that the rate of the charge and discharge test was changed to 0.33 C, and the discharge capacity of each test piece was evaluated. The results are illustrated in FIG. 12. The broken line in FIG. 12 represents the discharge capacity of the lithium ion secondary battery of Comparative Example 2.

As illustrated in FIG. 12, the discharge capacity of the lithium ion secondary battery of Comparative Example 2 using the positive electrode active material in which silicon dioxide was not supported on the lithium nickel manganese composite oxide was 142.9 mAhg⁻¹.

On the other hand, the discharge capacity of the lithium ion secondary battery of Example 2 using the positive electrode active material in which silicon dioxide was supported on the lithium nickel manganese composite oxide exceeded the discharge capacity of Comparative Example 2 when the mass ratio of silicon dioxide was more than 0% by mass and 2.0% by mass or less. From this, it was confirmed that when the mass ratio of silicon dioxide was more than 0% by mass and 2.0% by mass or less, the discharge capacity was further increased.

From the above results, it has been found that according to the present invention, a positive electrode active material capable of further increasing the discharge capacity and a lithium ion secondary battery including the positive electrode active material can be provided.

What is claimed is:

1. A cobalt-free positive electrode active material including a lithium nickel manganese composite oxide as a carrier,
particulate silicon dioxide is supported on a surface of the lithium nickel manganese composite oxide.

2. The positive electrode active material according to claim 1, wherein a mass ratio ((M₂/(M₁+M₂))×100) of a mass (M₂) of the particulate silicon dioxide to a sum (M₁+M₂) of the mass (M₁) of the lithium nickel manganese composite oxide and the mass (M₂) of the particulate silicon dioxide is more than 0% by mass and 2.0% by mass or less.

3. The positive electrode active material according to claim 1, wherein the particulate silicon dioxide has a particle diameter of 5 nm or more and 300 nm or less.

4. The positive electrode active material according to claim 1, wherein the lithium nickel manganese composite oxide has an average particle diameter of 0.25 to 10 μm.

5. A lithium ion secondary battery comprising a positive electrode, a negative electrode, and an electrolyte, wherein the positive electrode contains the positive electrode active material according to claim 1.
